(19) United States
(12) Patent Application Publication
(10) Pub. No.: US 2026/0131471 A1
(43) Pub. Date: May 14, 2026

(54) VISION GUIDED ROBOTIC PATH PLANNING FOR MATERIAL PROCESSING SYSTEMS

(71) Applicant: Hypertherm, Inc., Hanover, NH (US)

(72) Inventors: Waseem Khan, Kirkland (CA); Sanjay Garg, Hanover, NH (US); Mohammad Keshmiri, Thornhill (CA); Ben Morrow, Etna, NH (US); Edward M. Shipulski, Etna, NH (US)

(21) Appl. No.: 19/388,070

(22) Filed: Nov. 13, 2025

Related U.S. Application Data
(60) Provisional application No. 63/719,958, filed on Nov. 13, 2024.

(51) Int. Cl. B25J 9/16; B23K 10/00; B25J 11/00; B25J 13/08

(52) U.S. Cl. CPC B25J 9/1687; B23K 10/006; B25J 9/1664; B25J 9/1697; B25J 11/005; B25J 13/089

(57) ABSTRACT

A computer-implemented method is provided for designing a processing path to process a part from a workpiece by a material processing system. The method includes receiving a template point cloud for a reference workpiece and a template processing path for processing a reference part from the reference workpiece. The method also includes generating a workpiece point cloud comprising a set of spatial points defining the workpiece and aligning the workpiece point cloud with the template point cloud to determine a spatial mapping between the workpiece and the reference workpiece and between the part on the workpiece and the reference part on the reference workpiece. The method further includes producing a robotic program tailored to the workpiece that includes a processing path about the part on the workpiece that is generated based on the template processing path and the spatial mapping.

### CROSS REFERENCE TO RELATED APPLICATION

This application claims the benefit of and priority to U.S. Provisional Patent Application Ser. No. 63/719,958 filed on Nov. 13, 2024, which is owned by the assignee of the instant application and incorporated herein by reference in its entirety.

### TECHNICAL FIELD

The present invention generally relates to computer-implemented systems and methods for designing at least one processing path to process at least one part from a three-dimensional workpiece by a material processing system that includes a torch coupled to a robotic arm.

### BACKGROUND

In the field of material processing (e.g., cutting or marking) using industrial processing systems (e.g., plasma, waterjet, or laser systems), particularly material processing in a three-dimensional environment using robotic cutting solutions, tool path planning and robotic motion planning are complex, expensive, and intensive (both resource and timewise). For example, if a change is made to the design of the desired part or a unique workpiece is encountered, tool path planning and robotic motion planning for processing the workpiece and producing the part must be adjusted to account for the changes and variations. In addition, these paths and motions also need to be evaluated to determine if they will produce an acceptable processing (e.g., cutting) outcome. However, even slight adjustments and changes can be extremely time-consuming and computationally intensive and expensive.

Currently, most solutions for robotic tool path planning in industrial environments rely on a high level of human involvement to implement these adjustments for each design change and/or unique workpiece encountered. Common approaches include teaching the processing path to the robotic system via tracing, touching of the part with the end effector of the robot, using a sensor connected to the robot to locate the robot and the workpiece relative to one another and/or characterizing the workpiece to the robot (e.g., identifying workpiece features and shapes), in addition to inspecting and measuring the finished workpiece to determine if the new tool path is successful and produces a usable part. These multi-step and multi-resource solutions have high labor costs, high programming costs and requirements, increased fixturing demands and requirements, and significantly slow cell and system efficiency.

Therefore, systems and methods are needed that are capable of automatically generating a processing path for an integrated robotic processing system that minimizes human intervention, with the goal of efficiently and accurately processing desired part(s) relative to a workpiece in a three-dimensional environment.

### SUMMARY

The present invention features systems and methods for automatically determining a processing path to guide a three-dimensional robotic manufacturing system to process (e.g., cut) desired parts from a given workpiece.

In one aspect, a computer-implemented method is provided for designing at least one processing path to process at least one part from a three-dimensional workpiece by a material processing system that comprises a torch coupled to a robotic arm. The method comprises receiving, by a computing device in electrical communication with the material processing system, material processing system data, part data for the at least one part to be processed, a template point cloud for a reference workpiece that comprises a set of spatial points defining the reference workpiece, and at least one template processing path for processing at least one reference part from the reference workpiece. The method includes analyzing, by the computing device, the workpiece located within an operable envelope of the material processing system. Analyzing the workpiece includes locating, by the computing device, the workpiece within the operable envelope relative to the robotic arm, generating, by the computing device, a workpiece point cloud comprising a set of spatial points defining the workpiece, and aligning, by the computing device, the workpiece point cloud with the template point cloud to determine a spatial mapping between the workpiece and the reference workpiece. The method further includes producing, by the computing device, a robotic program tailored to the workpiece, wherein the robotic program includes a processing path about the at least one part on the workpiece generated based on the template processing path and the spatial mapping.

In some embodiments, the processing path for the at least one part has a plurality of path segments comprising one or more of an approach path segment, a retract path segment, and a cut path segment. At least one of the plurality of path segments is up-sampled compared to another segment in the plurality of path segments.

In some embodiments, generating the processing path for the at least one part comprises aligning the reference part of the reference workpiece with the at least one part of the workpiece based on the spatial mapping, up-sampling the template processing path corresponding to the reference part, and projecting the up-sampled template processing path onto the workpiece point cloud to generate the processing path. In some embodiments, aligning the workpiece point cloud with the template point cloud further comprises determining a spatial mapping between the at least one part on the workpiece and the at least one reference part on the reference workpiece.

In some embodiments, analyzing the workpiece further comprises scanning the workpiece to locate one or more visual indicators on the workpiece. In some embodiments, the one or more visual indicators include at least one of a drawn marking, raised ridge, detent, plasma-arc friendly ridge or trough, or a textured surface or path. The computing device can adjust the generated processing path to interpolate the one or more visual indicators. In some embodiments, the one or more visual indicators include a code embedded or cast into the workpiece. The computing device can adjust a plasma processing setting of the material processing system or a motion of the material processing system based on instructions included in the code.

In some embodiments, scanning the workpiece is performed by a set of non-contact sensors in electrical communication with the computing device. The set of non-contact sensors can communicate visual data of the workpiece to the computing device and the computing device can reconstruct an image of the workpiece based on the visual data to generate the workpiece point cloud. In some embodiments, at least one of the set of non-contact sensors has dynamic movement. In some embodiments, the set of non-contact sensors comprises a set of optical sensors. In some embodiments, at least one of the set of optical sensors is focused on a specific region of the workpiece that includes the one or more visual indicators marked across the workpiece, and the one or more visual indicators are up-sampled via the at least one optical sensor for adjusting the processing path.

In some embodiments, the at least one part to be processed from the workpiece comprises a plurality of parts to be processed, and the at least one template processing path includes a plurality of template processing paths for processing corresponding ones of a plurality of reference parts from the reference workpiece. In some embodiments, a plurality of processing paths are generated for respective ones of the plurality of parts by orienting and spatially mapping the plurality of reference parts of the reference workpiece to respective ones of the plurality of parts of the workpiece and projecting corresponding ones of the plurality of template processing paths on the workpiece to generate the plurality of processing paths. In some embodiments, at least one processing path of the plurality of processing paths includes a plurality of path segments comprising an approach path segment, a retract path segment, and a cut path segment, and at least one of the plurality of path segments is up-sampled. In some embodiments, one or more plasma settings of the torch are adjusted to accommodate a set of robotic motions for the robotic arm to transit from one part to another part of the plurality of parts over the workpiece during processing.

In some embodiments, the robotic program tailored to the workpiece further comprises identification of a set of motions for the robotic arm and a set of plasma processing parameters for the torch to process the workpiece along the processing path to form the at least one part. The set of robotic motions can comprise at least one of speed, angularity or tool center point (TCP) selection. In some embodiments, the robotic program is generated for a plasma arc processing system.

In some embodiments, the computing device actuates the robotic arm of the material processing system to cut the at least one part from the workpiece based on the robotic program, including the processing path. In some embodiments, up-to-code certification is performed after the at least one part is processed from the workpiece in accordance with the robotic program, and the up-to-code certification is automatically recorded. In some embodiments, the at least one part is assessed after it is processed from the workpiece for at least one of feedback, certification, cataloging of remnants, or quality determination. In some embodiments, adjusting one or more operating parameters of the material processing system is adjusted in response to real-time observations during processing of the workpiece in accordance with the robotic program. The one or more operating parameters can comprise a torch current adjusted in response to torch speed observations.

In some embodiments, the computing device generates the template point cloud and the at least one template processing path by scanning, by a set of sensors disposed about the operable envelope and in electrical communication with the computing device, images of the reference workpiece. The reference workpiece includes a set of visual indicators illustrating a desired processing path about the reference part. The computing device then generates the template point cloud comprising the set of spatial points defining the reference workpiece using a composite of the set of images. The computing device also generates the template processing path based on the visual indicators as captured by the set of images. The template processing path is defined by a set of spatial points interpolating one or more of the visual indicators and overlaying the template point cloud.

In another aspect, a computer-implemented method is provided for designing a processing path to process at least one part from a three-dimensional workpiece by a material processing system that comprises a torch coupled to a robotic frame having at least one robotic arm. The method comprises receiving, by a computing device in electrical communication with the material processing system, material processing system data, part data for the at least one part, and workpiece data for the workpiece. The part data or the workpiece data includes a template processing path for guiding processing of the at least one part from the workpiece. The method also includes locating, by the computing device, the workpiece within the operable envelope relative to the robotic frame to detect one or more visual indicators on the workpiece and generating, by the computing device, a workpiece point cloud for the workpiece located within the operable envelope. The workpiece point cloud includes a set of spatial points defining the workpiece. The method further includes projecting, by the computing device, the template processing path onto the workpiece point cloud to create an initial processing path for processing the part from the workpiece and generating, by the computing device, a final processing path by automatically adjusting the initial processing path based on the one or more visual indicators detected.

In some embodiments, the workpiece data corresponds to a reference workpiece having a similar geometry as the workpiece and the part data corresponds to a reference part having a similar geometry as the part to be processed from the workpiece. In some embodiments, at least one of the workpiece data or the part data is a CAD model. In some embodiments, at least one of the workpiece data or the part data is a point cloud. In some embodiments, the template processing path corresponds to a path for processing the reference part from the reference workpiece. In some embodiments, the workpiece point cloud corresponding to the workpiece is aligned with at least one of the workpiece data or the part data corresponding to the reference workpiece for guiding the projection of the template processing path onto the workpiece point cloud.

In some embodiments, adjusting the initial processing path comprises adapting the initial processing path to interpolate the one or more visual indicators. In some embodiments, the one or more visual indicators include at least one of a drawn marking, raised ridge, detent, plasma-arc friendly ridge or trough, or a textured surface or path. In some embodiments, the one or more visual indicators include a code embedded or cast into the workpiece. A plasma processing setting of the material processing system or a motion of the material processing system can be adjusted based on instructions included in the code.

In some embodiments, the final processing path has a plurality of path segments comprising one or more of an approach path segment, a retract path segment, and a cut path segment, and at least one of the plurality of path segments is up-sampled compared to the template processing path.

In some embodiments, locating the workpiece within the operable envelope relative to the robotic frame comprises scanning the workpiece to detect the one or more visual indicators on the workpiece. In some embodiments, scanning the workpiece is performed by a set of non-contact sensors in electrical communication with the computing device.

In yet another aspect, a material processing system is provided for cutting a part from a workpiece. The material processing system comprises a robotic arm possessing six degrees of freedom of movement in space, a plasma arc torch operably connected to the robotic arm, and a plurality of cameras disposed about the robotic arm and oriented to selectively analyze the workpiece located within an operable envelope of the robotic arm to generate a plurality of images. The material processing system also includes a computing device in electrical communication with the plurality of cameras. The computing device is configured to determine a processing path for the robotic arm across the workpiece based on a composite of the plurality of images.

In some embodiments, structured lighting is disposed about the operable envelope to introduce lighting variations.

In some embodiments, the computing device is in electrical communication with the robotic arm and configured to actuate the robotic arm to cut the part from the workpiece following the processing path. In some embodiments, the computing device is in electrical communication with a library. The library is configured to store at least one template point cloud comprising a set of spatial points defining a reference workpiece and a template processing path for processing at least one reference part from the reference workpiece.

In some embodiments, the computing device includes an input module configured to receive from a user data related to the material processing system and data related to the part to be cut and an analysis module configured to locate the workpiece within the operable envelope of the robotic arm using the plurality of images taken by one or more of the plurality of cameras, generate a workpiece point cloud comprising a set of spatial points defining the workpiece, and align the workpiece point cloud with the template point cloud to determine a spatial mapping between the workpiece and the reference workpiece and between the part and the reference part. The computing device also includes a computation module configured to generate the processing path about the part on the workpiece by projecting the template processing path onto the workpiece point cloud based on the spatial mapping. In some embodiments, the computation module of the computing device is further configured to adjust the processing path based on one or more visual indicators on the workpiece captured in the plurality of images.

In some embodiments, the computing device is configured to generate the processing path by interpolating one or more visual indicators on the workpiece about the part as captured in the plurality of images. In some embodiments, the computing device is further configured to identify at least one of a set of motions for the robotic arm or a set of plasma processing parameters for the plasma arc torch. The set of robotic motions can comprise at least one of speed, angularity or tool center point (TCP) selection.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary material processing system located within a manufacturing facility for cutting one or more parts from a three-dimensional workpiece, according to some embodiments of the present invention.

FIG. 2 shows an exemplary workpiece with one or more parts to be processed by the material processing system of FIG. 1, according to some embodiments of the present invention.

FIG. 3 shows an exemplary block diagram of a path planning application executable by the computing device of the material processing system of FIG. 1 for generating a planned processing path, according to some embodiments of the present invention.

FIG. 4 shows an exemplary method implemented by the path planning application of FIG. 3 and utilizing the components in the material processing system of FIG. 1 to generate a recommended processing path for processing at least one desired part from a three-dimensional workpiece, according to some embodiments of the present invention.

FIG. 5 shows a portion of an exemplary workpiece having a set of markings that delineates a desired processing path about a part to be cut from the workpiece, according to some embodiments of the present invention.

FIG. 6 shows an exemplary image of virtual mark tracing that is overlaid on a workpiece point cloud and another exemplary image of the virtual mark tracing on the workpiece itself, according to some embodiments of the present invention.

FIG. 7 shows an exemplary implementation of step 612 of the process of FIG. 4 for determining a recommended path for processing a desired part from a workpiece using a reference workpiece, according to some embodiments of the present invention.

FIG. 8 shows an exemplary workpiece with one or more encodings incorporated as a designed feature into the workpiece, according to some embodiments of the present invention.

FIG. 9 shows another exemplary workpiece with parts that can be severed from the workpiece using the material processing system of FIG. 1 by executing the path planning method of FIG. 4, according to some embodiments of the present invention.

### DETAILED DESCRIPTION

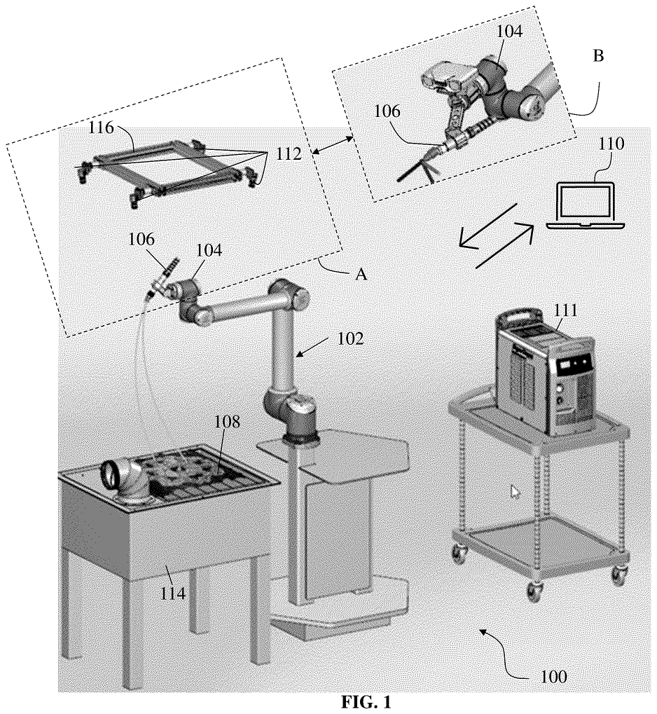

FIG. 1 shows an exemplary material processing system 100 located within a manufacturing facility for cutting one or more parts from a three-dimensional workpiece, according to some embodiments of the present invention. As shown, the material processing system 100 includes a robotic frame 102 having at least one robotic arm 104 mounted thereto. The robotic arm 104 in conjunction with the robotic frame 102 (which may serve as a reference coordinate system) is configured to hold and manipulate a processing torch 106 to process (e.g., cut) a workpiece 108 in accordance with a customized program, including a planned processing path for the robotic arm 104 as determined by a computing device 110. In some embodiments, the computing device 110 is in electrical communication with the robotic frame 102 (including the robotic arm 104) and the processing torch 106 to automate or otherwise direct the respective devices to configure themselves and operate based on the recommended program (e.g., components, settings and/or paths) for processing (e.g., cutting) the workpiece 108.

In some embodiments, the workpiece 108 is mounted on a downdraft cutting table 114 of the material processing system 100 and located within an operable envelope of the robotic arm 104. An operable envelope can be defined as the space within which the robotic arm 104 can reach and process the workpiece 108. In some embodiments, the processing torch 106, which is held by the robotic arm 104, is a plasma arc torch with consumables disposed on the torch 106 to cut the workpiece 108 by a plasma arc. The plasma arc torch 106 can be connected to a plasma power supply 111 for setting appropriate parameters to operate the torch 106. Alternatively (not shown), the robotic arm 104 can hold the workpiece 108 and manipulate the workpiece 108 about one or more fixed torches 106 (e.g., fixed to the cutting table 114) to perform the processing by following the recommended processing path(s) generated using the systems and methods described herein.

In some embodiments, the robotic arm 104 possesses six degrees of freedom in terms of movement along six axes, which include three axes defining a translation motion and three axes defining a rotation motion. More specifically, a translation motion of the robotic arm 104 can be defined with respect to the x-axis, y-axis and z-axis. A rotational motion of the robotic arm 104 can be defined with respect to the main rotational axis, a tool axis that defines the direction of the torch 106 mounted on the robotic arm 104 (e.g., the direction of the nozzle of the torch 106), and a third axis that is normal to both the main and tool axes.

In some embodiments, a set of one or more non-contact sensors 112 (e.g., cameras, lasers, etc.), is disposed adjacent to the workpiece 108, but without maintaining physical contact with the workpiece 108, the cutting table 114, and/or the robotic frame 102. For example, as shown in insert A of FIG. 1, the set of non-contactor sensor 112 can be a ceiling-mounted, multi-camera stereo vision system, which includes a plurality of cameras (e.g., 4 cameras as shown in FIG. 1) in electric communication with the computing device 110. As another example, as shown in insert B of FIG. 1, the set of non-contact sensors 112 (e.g., an array of cameras) can be mounted on the robotic arm 104 and are transited about the workpiece 108 and/or the operable envelope by the robotic arm 104 in a known set path to obtain a set of images of the workpiece 108 at varied angles to generate the visual data. In some of these embodiments, the set path includes a set of vantage points where the array of cameras 112 are paused at one or more corners of the operable envelope to generate the visual data from those known vantage points. Visual data collected from the non-contact sensors 112, in conjunction with process variables and attributes (e.g., cut charts, consumable lengths, etc.) received as inputs from a user, can be used by the computing device 110 to generate a customized program for the robotic arm 104, including one or more processing paths and robotic motion commands, as described in detail below. As an example, the sensors 112 can be spaced relative one another so as to provide the computing device 110 with a plurality of varied frames of reference/viewpoints of the workpiece 108 (e.g., different distances and/or angles of sensor incidence on the workpiece 108 and features and shapes thereof). The computing device 110 is configured to process and/or correlate data obtained from this set of sensors 112 and generate a composite of the images taken by the sensors 112. The composite image can be used by the computing device 110 to locate and orient the workpiece 108 and the one or more parts to be cut from the workpiece 108 in relation to the robotic frame 102. In some embodiments, visual data collected from the set of sensors 112 can assist the computing device 110 in locating certain features of interest on the part, such as those to be processed and/or those to inform the processing path, which is described in detail below.

In some embodiments, as shown in FIG. 1, the non-contact sensors 112 are each coupled to a rectangular frame 116, such as to the corners of the rectangular frame 116. This configuration allows the sensors 112 to convey to the computing device 110 a plurality of views of the workpiece 108, including features on the workpiece 108, which can be evaluated by the computing device 110 to assist with subsequent point cloud generation and/or tool path planning. A point cloud can be defined as a set of spatial coordinates representing key surface points of a workpiece, where the point cloud is not a fully solid model (e.g., not a Computer-Aided Design (CAD) file of the workpiece or portions thereof). Thus, a point cloud is generally associated with less data than a CAD model. These spatial coordinates can be captured by correlation and comparison of data generated by the set of non-contact sensors 112 (e.g., cameras, lasers, etc.) for a workpiece and/or portions of a workpiece. In general, using such a non-contact imaging approach provides a scalable solution scanning for different workpiece sizes as well as facilitates creation of a customizable Field-Of-View (FOV) to accommodate workpiece shape varieties. The point cloud can have varying levels of resolution/data density dependent upon the different identified areas of the workpiece 108. For example, areas of the workpiece 108 identified as biscuits or runners are categorized as low resolution while areas identified as desired parts and the cut paths located there about are categorized as high resolution.

In some embodiments, a user can provide inputs to the set of non-contact sensors 112 (e.g., via the computing device 110) for calibrating the sensors 112. For example, these inputs can be provided to a vision kernel for multi-view calibration, hand-eye calibration, and/or three-dimensional shape reconstruction via utilization of a comprehensive machine vision library. The vision kernel may assist with and/or direct imaging tasks that include, but are not limited to, image acquisition and processing, segmentation, measurements, two-dimensional and/or three-dimensional object detection and matching, three-dimensional vision (e.g., binocular or multi-camera stereo), camera calibration; and/or robot-camera calibration. In some embodiments, a calibration target is used for camera calibration and/or hand-eye calibration. In some embodiments, a calibration target is also used for validation by defining an arbitrary location and orientation in space and/or checking a combined result of calibrations previously performed. In some embodiments, for calibration purposes, the set of non-contact sensors 112 are transited along a calibration path about the operable envelope and/or the workpiece 108 as illustrated in Insert B of FIG. 1.

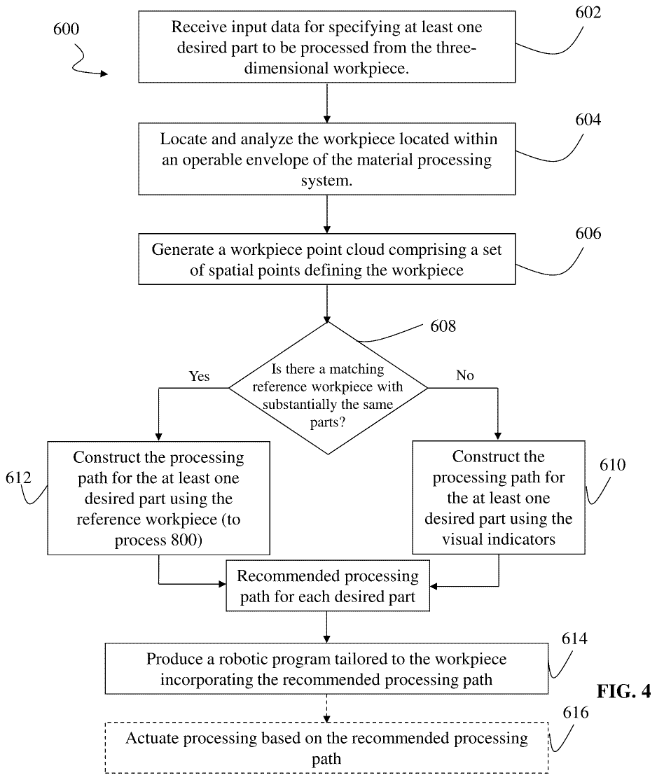

In some embodiments, the set of non-contact sensors 112 are optical sensors. In some embodiments, the set of non-contact sensors 112 are multi-view cameras, where each camera may have an optical center. For example, 2, 3, 4, 5 or even more cameras can be a part of the vision system comprising the non-contact sensors 112. These cameras 112 can observe the workpiece 108 on the cutting table 114 from varied locations to subsequently generate a point cloud of the workpiece 108 via cooperation with the computing device 110 using, for example, comparison, correlation, and processing of the various images from each of the multiple cameras (or specific portions of the workpiece 108) and then use the generated point cloud to virtually realize/represent the workpiece 108, as described below in detail with reference to FIG. 4. To calibrate these multi-view cameras, the computing device 100 can relate image points taken by the cameras 112 to physical locations in space to determine camera and lens parameters (e.g., lens focal length, distortion parameters, locate camera and lens optical axis, etc.).

In some embodiments, calibration of the camera 112 includes determination of and consideration for the variables of the material processing system 100, degrees of freedom of the robotic arm 104, and relative limitations. As an example, to calibrate two non-contact sensors 112 (e.g., two cameras) within the material processing system 100 of FIG. 1 (where the two sensors 112 have optical centers spaced and angularly oriented relative to an object point on a workpiece to provide varied viewpoints on the object point), first virtual image planes corresponding to the two cameras 112a, 112b are generated. Then, the computing device 110 is configured to convert image coordinates from the virtual image planes to physical coordinates for use in tool path planning of a generated point cloud.

In some embodiments, one or more of the non-contact sensors 112 are dynamic (e.g., articulating, oscillating, etc.). Each of the dynamic non-contact sensors 112 can move positions between image captures, thereby providing multiple viewpoints, frames of reference and/or angles on a given feature from each sensor 112. In some embodiments, the material processing system 100 accounts for, provides for and/or deliberately induces lighting variations to improve the robustness and precision of the set of non-contact sensors 112. For example, structured lighting can be located about the operable envelope of the robotic arm 104 to ease visual interpretation of the workpiece 108 via the non-contact sensors 112 and the computing device 110, such as by providing enhanced contrast, improved clarity, etc. As discussed herein, in some embodiments, the non-contact sensors 112 are moved about the operable envelope and/or the workpiece 108 via robotic arm 104 or another robotic arm. In some embodiments, the set of non-contact sensors 112 includes a non-contact sensor disposed on robotic arm 104.

FIG. 2 shows an exemplary workpiece 108 with one or more parts 402 to be processed by the material processing system 100 of FIG. 1, according to some embodiments of the present invention. As shown, the workpiece 108 can be an aluminum casting of multiple parts 402 comprising eight brake calipers to be trimmed off from the casting workpiece 108. The material processing system 100 can analyze this casting workpiece 108 to determine the appropriate tool path(s) to sever each brake caliper part 402 from the singular casting and create multiple useable brake calipers 402. During operation, the casting workpiece 108 is disposed on the cutting table 114 for analysis and processing by the system 100. In some embodiments, no additional fixture is used to locate the casting workpiece 108 in a specific orientation before the material processing system 100 determines appropriate tool paths about the workpiece for cutting respective ones of the brake calipers 402 from the casting workpiece 108. In alternative embodiments, no such fixture is required; a workpiece 108 can be placed in any orientation on the cutting table 114 for path determination using the systems and methods of the present invention.

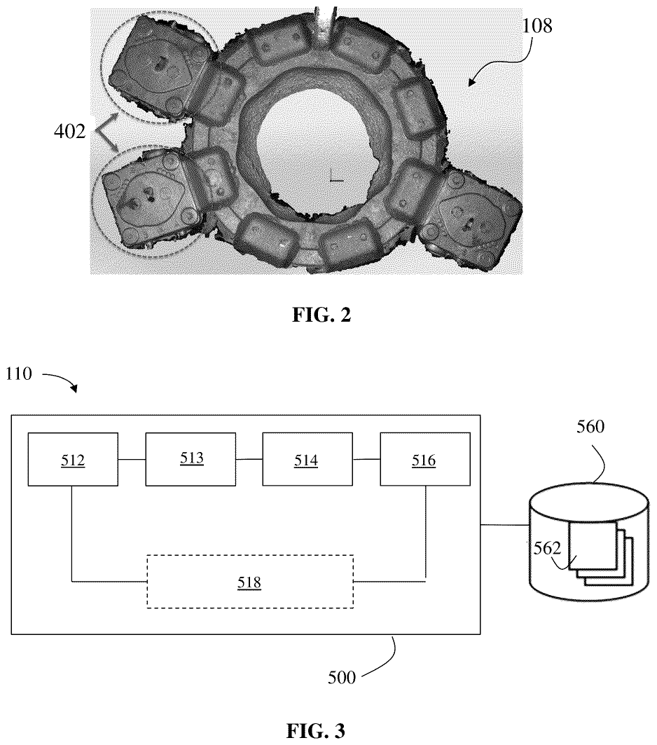

FIG. 3 shows an exemplary block diagram of a path planning application 500 executable by the computing device 110 of the material processing system 100 of FIG. 1 for generating a planned processing path, according to some embodiments of the present invention. The resulting processing path is adapted to guide the robotic arm 104 and/or the torch 106 of the material processing system 100 to process one or more desired parts from a given workpiece, such as the eight brake caliper parts 402 from the casting workpiece 108 of FIG. 2.

As shown, the path planning application 500 generally includes an input module 512, an analysis module 513, a computation module 514, an optional display module 516 and an optional actuation module 518. These modules 512-518 can be implemented in hardware only or in a combination of hardware and software to execute the path determination methods described below. More specifically, the input module 512 is configured to receive and process data from a user, such as data related to the material processing system 100 and/or data related to the part(s) to be cut from the workpiece 108, which is described in detail below. The data can be in the form of any suitable data structures, such as textual lists, XML documents, class objects (e.g., instances of C++ or Java classes), other data structures, or any combination thereof.

The analysis module 513 is configured to locate the workpiece 108 on the cutting table 114 and within an operable envelope of the material processing system 100 with the aid of the set of sensors 112 of the material processing system 100. Based on the visual data collected by the sensors 112, the analysis module 513 can generate a workpiece point cloud comprising a set of spatial points defining the workpiece 108. In some embodiments, if there exists a prior a template point cloud for a reference workpiece (i.e., a set of spatial points defining the reference workpiece) along with one or more template processing paths for processing one or more reference parts from the reference workpiece, the analysis module 513 can determine a spatial mapping between the workpiece to be processed and the reference workpiece and between the part(s) to be processed and the reference part(s), as described in detail below. The reference workpiece is similar in dimension to the workpiece to be processed, and the reference part(s) of the reference workpiece have similar dimensions and relative locations as the corresponding part(s) to be processed from the input workpiece.

The computation module 514 is configured to determine a robotic program for the workpiece based on the workpiece point cloud generated and optionally, the mapping between the workpiece to be processed and the reference workpiece (if the reference workpiece exists). The robotic program can include one or more recommended processing paths for operating the torch 106 mounted on the robotic arm 104 of the material processing system 100 to form (e.g., cut) one or more desired parts from the input workpiece. The robotic program can also include one or more of recommended motions, orientations, manipulations, etc. for the robotic arm 104 as well as a recommended selection of consumables and/or parameter settings for the torch 106 to execute each recommended processing path, the details of which are provided below.

The optional display module 516 is configured to visualize the recommended motions of the robotic arm 104 (as calculated by the computation module 514) in a virtual simulation. More specifically, the display module 116 can visually illustrate how the torch 106 mounted on the robotic arm 104 processes a workpiece 108 while following the recommended processing paths, sequence of motions, part selections, parameters and/or other constraints. Such a display encourages user interaction with the path planning system 102 to change and/or refine the parameters for motion planning.

The optional actuation module 518 can (i) instruct the power supply 111 and/or the torch 106 to be configured with the recommended consumables and/or parameter settings determined by the computation module 514 and/or (ii) actuate the robotic arm 104 to follow a sequence of motion captured in the processing path calculated by the computation module 514, with the goal of processing the desired parts from the input workpiece 108. In general, the optional actuation module 518 can communicate with any one of the modules 512-516 to obtain the pertinent information for automatically actuating the robotic arm 104 and/or configuring the torch 106 in accordance with the robotic program produced. In some embodiments, actuating the robotic arm 104 includes joint selection for movements of robotic arm 104 as it transits torch 106 along the path.

The computing device 110 can further include a memory 560 that is configured to communicate with one or more of the modules 512-518 of the path planning application 500. For example, the memory 560 can be used to store data processed by the input module 512, image data collected by the set of sensors 112, workpiece point cloud (and optionally mapping data) generated by the analysis module 513, one or more functions and values used by the computation module 514 to determine the processing path, and/or instructions formulated by the optional actuation module 518 to direct the movement of the robotic arm 104 and/or consumable setup for the torch 106. In some embodiments, memory 560 can store at least a portion of a library 562 of template point clouds associated with reference workpieces and/or template processing paths associated with processing reference parts from the corresponding reference workpieces.

Even though the actuation module 518 is illustrated as a part of the path planning application 500, in some embodiments, it is absent from the path planning application 500 and/or from the computing device 100. For example, a separate application and/or device (not shown) can receive the planned robotic program from the path planning application 500 and actuate the robotic arm 104 and the torch 106 accordingly. Even though the present invention describes generating one or more processing paths for controlling a robotic arm having a plasma processing tool mounted thereto, a person of ordinary skill in the art can appreciate that the systems and methods of the present invention are easily adaptable to any processing tool mounted to the robotic system 104 to perform any type of processing tasks relative to a given workpiece. An exemplary processing tool can be a plasma arc torch, waterjet device, welding torch, paint sprayer, or laser processing tool. An exemplary processing task can be a cutting, marking, welding, painting or gouging operation.

FIG. 4 shows an exemplary method 600 implemented by the path planning application 500 of FIG. 3 and utilizing the components in the material processing system 100 of FIG. 1 to generate a recommended processing path for processing at least one desired part from a three-dimensional workpiece, according to some embodiments of the present invention.

As shown, generating a recommended processing path involves the input module 512 of the path planning application 500 receiving and processing data needed to determine the processing path (step 602). The input data can include part data provided by a user for specifying the at least one desired part to be processed from the three-dimensional workpiece. For example, part data can comprise a part file and can include data related to part quality, shape, material, etc. In some embodiments, the input data includes material processing system information related to the torch 106, such as the consumables connected to the torch 106 and their settings/capabilities and/or an identification of the type of torch 106 to be used for the processing task (e.g., gas cooled plasma arc torch, liquid cooled plasma arc torch, etc.). The input module 102 can receive the torch data from the user and/or automatically obtain the data via electrical communication between the computing device 110 and the power supply 111. In some embodiments, the input data includes material processing system information for controlling and manipulating the robotic arm 104. For example, the robotic data can be an identification of the robot type to be used for the processing task (e.g., ABB IRB2400). The input module 102 can receive such data from the user and/or automatically obtain the data via electrical communication between the computing device 110 and the robotic frame 102.

In some embodiments, the path planning application 500 is in electrical communication with the library 562 located in memory 560 that stores template point clouds for corresponding ones of a set of reference workpieces. Each template point cloud can include a set of spatial points defining a reference workpiece. Additionally, for each reference workpiece, the library 562 can store one or more template processing paths for guiding the robotic arm 104 to process (e.g., cut) a set of one or more reference parts from the reference workpiece. The template point clouds and/or the template processing paths are adapted to facilitate efficient generation of processing paths for processing similar parts from similar workpieces, as described below.

At step 604, the analysis module 513 of the path planning application 500 is configured to analyze the input workpiece 108 that is disposed on the cutting table 114 and located within an operable envelope of the robotic arm 104 of the material processing system 100. This may involve the analysis module 513 of the computing device 110 activating the set of non-contact sensors 112 (e.g., a multi-camera stereo vision system) that are spaced relative to each other and oriented at different vantage points/angles about the cutting table 114 to take images of the workpiece 108 from the various vantage points/angles. The analysis module 513 can communicate with the non-contact sensors 112 to obtain the images of the workpiece 108 and calibrate these images to reconstruct a composite image of the workpiece 108, such as using the calibration process explained above, thereby spatially locating the workpiece 108 within the operable envelope relative to the robotic arm 104. An advantage of this approach is that no special fixturing of the workpiece 108 on the cutting table 114 is required to reconstruct the final image or perform the downstream image analysis.

In some embodiments, the workpiece 108 has one or more visual indicators that are captured in the images taken by one or more of the non-contact sensors 112. The one or more visual indicators can be at least one of a drawn marking, raised ridge, detent, plasma-arc friendly ridge or trough (e.g., shaped to influence cut quality along that edge, shaped to promote slag direction and adhesion during and following cutting, etc.), or a textured surface or path on the workpiece 108. In some embodiments, the one or more visual indicators comprise a code (e.g., a barcode, a numerical code, a process symbol, a quality indicator, etc.) embedded or cast into the workpiece 108 and detectable by the combination of the non-contact sensors 112 and the analysis module 513. The visual indicators, which can be made (e.g., drawn) by a technician manually or automatically created via a separate process or system, are configured to be easily detectable by the non-contact sensors 112 and the analysis module 513.

At step 606, the analysis module 513 is adapted to generate a workpiece point cloud using the composite image determined from step 605. In some embodiments, the workpiece point cloud includes a set of points in the three-dimensional space defining the workpiece. In general, a point cloud can be defined as a set of spatial coordinates representing key surface points of a workpiece. In some embodiments, a point cloud model is not a fully solid model (e.g., not a Computer-Aided Design (CAD) file of the workpiece or portions thereof). Thus, a point cloud is less data intensive than a CAD model.

At step 608, based on the workpiece point cloud generated for the input workpiece 108, the analysis module 513 is adapted to determine whether there is a reference workpiece that has substantially the same geometry as the input workpiece 108 to be processed. This determination can be made by comparing the workpiece point cloud generated at step 606 for the input workpiece 108 with each template point cloud corresponding to a reference workpiece stored in the library 562. In addition, the comparison involves whether the one or more desired parts to be processed from the input workpiece 108 have substantially the same location and geometry as the corresponding reference parts relative to the reference workpiece. As an example, the comparison can be accomplished by overlaying the point clouds with one another and determining if they are the same net shape and/or how out of rotation/position they are relative to one another within the operable envelope.

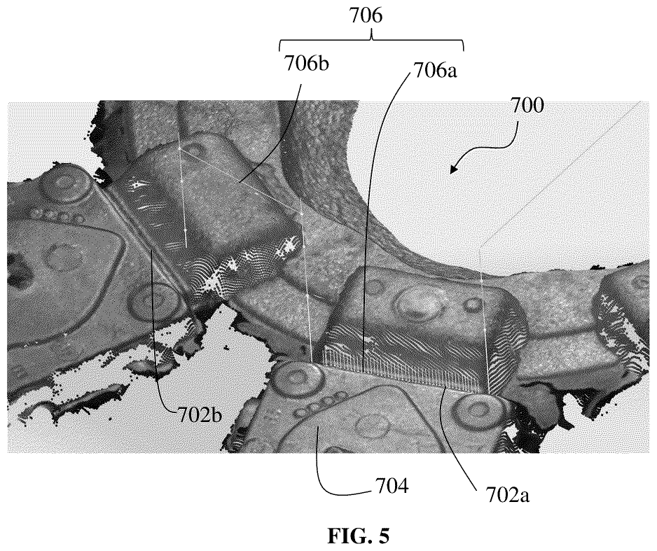

If no reference workpiece is found in the library 562 with substantially the same dimension as the input workpiece 108 that has part(s) with substantially the same dimension(s) and location(s) as desired parts to be processed from the input workpiece 108, the process 600 proceeds to step 610 to construct the processing path for the workpiece 108 using the visual indicators detected (from step 604). In some embodiments, the visual indicators can delineate a desired process, cut recipe, cut quality, processing route, etc. around each desired part relative to the workpiece 108. FIG. 5 shows a portion of an exemplary workpiece 700 having a set of markings 702a, 702b that collectively delineates a desired processing path about a part 704 (e.g., a brake caliper) to be cut from the workpiece 700, according to some embodiments of the present invention. As shown, the markings 702a, 702b can collectively form a traced path (e.g., in color) around the desired part 704. The traced path can be hand-drawn by a technician (or automatically generated via another mechanism) directly onto the workpiece 700. For example, a technician can mark estimated processing routes (e.g., segments 702a, 70b) on the cast workpiece 700 and the non-contact sensors 112 (e.g., a multi-camera vision system) in conjunction with the computing device 110 of the material processing system 100 are adapted to detect and create the recommended processing path 706 based on these markings 702a, 702b. In some embodiments, during scanning by the set of non-contact sensors 112, at least one of the sensors 112 is adapted to automatically focus on the specific regions of the workpiece 108 that includes the visual indicators marked across the workpiece 108. In some embodiments, a visual indicator is up-sampled via at least one of the set of sensors 112. For example, if a visual indicator is identified by a sensor 112, the system 100 may take another higher resolution image of the visual indicator or further process the portion of the image with the visual indicator to generate more data points (increase resolution) in the area for improving analysis, planning and control, such as ensuring proper actions are taken and the visual indicator is interpreted correctly.

More specifically, at step 610 of FIG. 4, the computation module 514 of the path planning application 500 is configured to generate a processing path for each desired part on the input workpiece 108 by interpolating the visual indicators detected on the workpiece 108. With reference to the exemplary workpiece 700 of FIG. 5, a recommended processing path 706 about the desired part 704 is shown partially completed with one segment 706a of the processing path 706 tracing/interpolating the hand-marked segment 702a on the workpiece 700. The computation module 514 can program the processing path segment 706a as a set of spatial points across/overlaying the workpiece 700 selected from the point cloud of the workpiece 700. More specifically, because a point cloud comprises an array of points representing the surface of the workpiece, when a cut path is identified, the points within the point cloud that are along that desired cut path are selected to represent the location at which processing is going to take place. The computation module 514 continues to progress toward developing the latter portion of the processing path 706 by interpolating and programming the second hand-marked segment 702b on the workpiece 700. The resulting complete processing path 706 (including segments 706a and 706b) is adapted to sever the brake caliper 704 from the workpiece 700. In general, the computation module 514 is adapted to combine the visual indicators (e.g., markings 702a, 702b) of the desired cut route detected from the workpiece 700 with the visual data from the set of non-contact sensors 112 (which is used to generate the workpiece point cloud) to create the recommended processing path 706. FIG. 5 also illustrates that the resulting processing path 706 for the desired part 704 of the workpiece 700 can have multiple path segments with varying granularity (i.e., number of points defining that segment). For example, the processing path can include one or more of an approach path segment for routing the robotic arm 104 and the torch 106 to approach a desired part, a cut path segment (e.g., segment 702a of FIG. 5) for routing the robotic arm 104 and the torch 106 around the part for severing the part from the workpiece 108, and a retract path segment (e.g., segment 706b of FIG. 5) for routing the robotic arm 104 and the torch 106 to move to another desired part on the workpiece 108 for further processing (if there are multiple desired parts) or move away from the workpiece 108 (if there is only one desired part). In some embodiments, at least one of these path segments of a processing path is up-sampled (i.e., more granular and has more spatial points defining the segment, such as at a higher resolution) compared to other segments of that path. For example, the cut path segment may be more detailed than the approach path segment and/or the retract path segment.

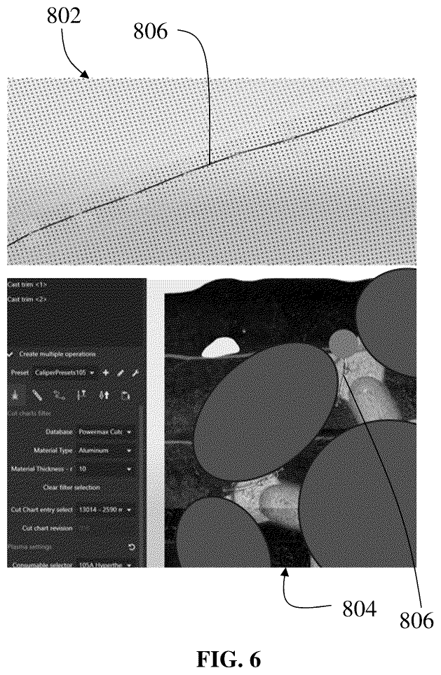

As described above, the computation module 514 can generate a processing path by tracing visual indicators (e.g., hand-drawn segments, cast features or segments into the surface of the workpiece indicating the desired cut path, etc.) on the workpiece and program the virtual mark tracings as a set of spatial points selected from the point cloud of the workpiece. FIG. 6 illustrates (i) an exemplary image 802 showing virtual mark tracing 806 that is overlaid on a workpiece point cloud and (ii) another exemplary image 804 of the virtual mark tracing 806 on the workpiece itself, according to some embodiments of the present invention. These two images 802, 804 illustrate that the processing path can be produced via visual indicator detection (e.g., color detection of the markings), segmentation of separate clusters of markings, trace of each segment via interpolation of each cluster of markings, and up-sample of the point cloud on each segment to quickly and efficiently create the processing path about the workpiece. For example, up-sampling may involve advanced processing to increase the resolution and/or granularity of data points in this region of the workpiece for accurate data and control and more precise operation.

Thus, the visual indicators on a workpiece allow the computation module 514 to easily identify the desired processing path(s) and highlight them for quick processing relative to a point cloud of the workpiece. That is, the computation module 514 can easily incorporate the visual indicators into the resulting recommended processing path via tracing. In some embodiments, the computation module 514 is adapted to store the workpiece point cloud along with the recommended processing path generated for the corresponding part as a reference for future usage. More specifically, the workpiece point cloud can be stored as a template point cloud, the part information can be stored as a reference part, and the recommended processing path can be stored as a template processing path to guide processing of other workpieces/parts with similar geometries.

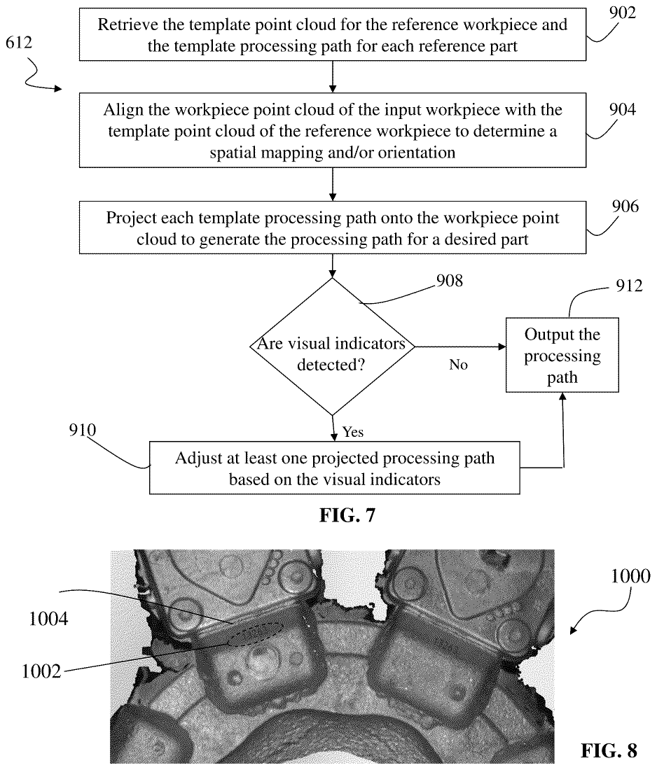

Alternatively, if the analysis module 513 determines at step 608 that there is a reference workpiece with reference part(s) that matches the input workpiece 108 and the desired part(s), the analysis module 513 is adapted to construct the processing path for each desired part of the input workpiece 108 based on the reference workpiece at step 612. FIG. 7 shows an exemplary implementation of step 612 of process 600 for determining a recommended path for processing a desired part from a workpiece using a reference workpiece, according to some embodiments of the present invention. At step 902, the analysis module 513 is adapted to retrieve from the library 560 the template point cloud defining the matched reference workpiece along with the template processing path for processing (e.g., cutting) each reference part from the reference workpiece 562. At step 904, the computation module 514 is configured to align the workpiece point cloud of the input workpiece 108 (calculated at step 604) with the template point cloud of the matched reference workpiece to determine a spatial mapping and/or orientation between the workpieces as well as a spatial mapping and/or or orientation between the desired part(s) to be processed from the input workpiece 108 and the reference part(s) on the reference workpiece 562. At step 906, the alignment allows the computation module 514 to project the template processing path (which is generated a priori) for each reference part onto the workpiece point cloud of the input workpiece 108 for processing corresponding ones of the desired part(s) of the input workpiece 108 (e.g., visually overlaying the processing path(s) on to the workpiece). Thus, each projected processing path becomes the recommended processing path for processing a desired part from the workpiece 108 given the detected orientation and configuration without any additional computation. In some embodiments, at least a portion of a template processing path is up-sampled (i.e., increased in granularity) when projected onto the workpiece point cloud.

At step 908, the computation module 514 determines if visual indicators are detected on the workpiece 108. If no visual indicators are detected, the computation module 514 outputs the projected processing path at step 912 without further computation. Alternatively, if visual indicators are detected, the computation module 514 at step 910 can suitably adjust the projected processing path (from step 906) based on the visual indicators. For example, the computation module 514 can modify a projected processing path to interpolate any markings on the input workpiece 108. Therefore, in the case where a template workpiece and template processing path(s) already exist, the visual indicators serve as a guide to adjust the projected processing path(s) and/or process(es). Then, the computation module 514 proceeds to step 912 to output the adjusted path as the processing path for the desired part.

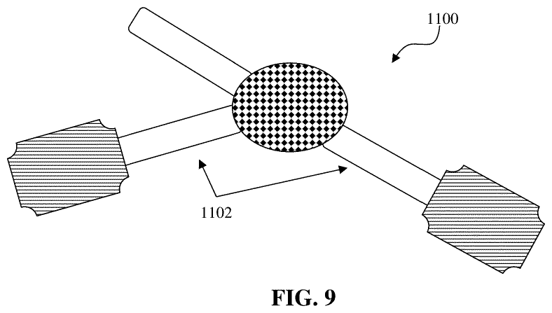

Referring back to FIG. 4, the processing path(s) constructed from either step 610 or 612 constitute the recommended path(s) for processing corresponding ones of the desired part(s) from the input workpiece 108. As described above, in either step 610 or step 612, any visual indicators, such as markings 702a, 702b described with reference to FIG. 5 or other designed features on the input workpiece can be easily recognized/detected by the non-contact sensors 112 of the material processing system 100 and accounted for/incorporated in the resulting recommended path(s) by the computing device 110 of the material processing system 100. In some embodiments, these designed features are features cast or machined into the workpiece and can be used instead of markings to detect and generate processing paths (e.g., hone the non-contact sensors 112 into key portions or components of the workpiece). These designed features are cast into the part itself and can be raised ridges, detents, plasma arc friendly ridges or troughs shaped to promote and/or produce a desirable cut edge, etc. In these embodiments, the designed features are shaped to interact with specific manufacturing processes (e.g., specific plasma arcs) to produce a desirable outcome and enhance results of the manufacturing process. In some embodiments, these designed features can include pre-marked text or symbols as that can be detected to automate preset selections for one or more operating parameters. FIG. 8 shows an exemplary workpiece 1000 with one or more encodings 1002 incorporated as a design feature into the workpiece 1000, according to some embodiments of the present invention. In this example, the encodings 1002 represent a serial number configured for easy identification via the non-contact sensors 112 and processing by the computing device 110. This serial number 1002 can be correlated to a plasma processing setting for the torch 106 of the material processing system 100 or a motion instruction of the robotic arm 104 of the material processing system 100 and the computing device 110 can adjust these parameters accordingly. In some embodiments, the visual indicator (e.g., serial number 1002) indicates a specific mold or cast used to produce that workpiece and enables the material processing system 100 to make adjustments (e.g., process, path, etc.) tailored to that specific mold in comparison to a different mold designed to form the same workpiece, thereby allowing for the material processing system 100 to compensate for slight variations between comparable molds on workpieces. As shown in FIG. 8, the encodings 1002 can be present with one or more additional visual indicators, such as markings 1004 to indicate at least a portion of a desired processing path on the workpiece 108.

In some embodiments, the recommended path(s) constructed from either step 610 or step 612 of process 600 by incorporating the visual indicators on the workpiece 108 do not require a solid CAD model of the workpiece 108. Instead, point cloud construction of the workpiece 108 is used, thereby allowing for less data intensive path development with flexibility for unique workpieces and workpiece variations. Alternatively, at step 606, the analysis module 513 can represent the workpiece 108 as a CAD model instead of a point cloud. Furthermore, one or more reference workpieces located in memory 560 can be represented as a CAD model instead of a point cloud. The analysis module 513 can be suitably configured to compare two workpieces both in the form of point clouds, both in the form of CAD models or one in the form of a point cloud and the other in the form of a CAD model.

In some embodiments, a recommended processing path is generated by the path planning application 500 for each desired part (e.g., a brake caliper 402 of FIG. 2) of the input workpiece 108. Therefore, if there are multiple parts present in the workpiece 108 that need to processed by the material processing system 100, the path planning application 500 can generate multiple recommended processing paths for corresponding ones of the set of desired parts. For example, the application 500 can determine whether there is a template point cloud stored in the library 560 for a reference workpiece that comprises a substantially similar geometry as the input workpiece 108 and has multiple reference parts that are substantially similar in locations and geometries as the desired parts to be processed from the input workpiece 108. If such a reference workpiece exists, the path planning application 500 is adapted to execute step 612 as described above by orienting and spatially mapping the plurality of reference parts of the reference workpiece to respective ones of the plurality of desired parts of the input workpiece 108 and projecting corresponding ones of the plurality of template processing paths for the reference parts onto the point cloud of the input workpiece 108 to generate the recommended processing paths. Alternatively, if no such reference workpiece is found, the application 500 is adapted to execute step 610 by generating the processing paths for the desired parts using only the visual indicators as described above.

At step 614 of process 600 of FIG. 4, the computation module 514 of the path planning application 500 is configured to produce a robotic program tailored to the input workpiece 108 that incorporates the processing path (determined at either step 610 or 612) about each desired part on the workpiece 108. Specifically, the robotic program can combine customized process variables and robotic system attributes with the recommended processing path(s) for processing the desired part(s) from the workpiece 108 utilizing the components of the material processing system 100. To this end, the computation module 514 can identify a set of motions for the robotic arm 104 and/or a set of plasma processing parameters for the torch 106 to optimally process the workpiece 108 along the recommended processing path to form each part. The set of robotic motions comprises, for example, at least one of speed, angularity or tool center point (TCP) selection. In some embodiments, if multiple parts need to be cut from the input workpiece 108, the robotic program can adjust one or more plasma settings of the torch to accommodate a set of robotic motions for the robotic arm 104 to transit from one part to another part over the workpiece 108 during processing.

In optional step 616, the actuation module 518 of the path planning application 500 can actuate the torch 106 and/or the robotic arm 104 to execute the recommended processing path(s) relative to the input workpiece 108. In some embodiments, the display module 516 of the path planning application 500 is configured to provide a preview function that visually displays to the user the recommended processing path(s) before the actual processing by the actuation module 518. The preview mode can include an edit function that allows the user to modify at least one recommended processing path before the actual processing. In some embodiments, path planning includes determining camera pose(s) relative to the world coordinate system (WCS) as well as inter-camera poses (i.e., relative poses of one camera with respect to another) to adjust how visual data can be collected, such that more detailed and accurate images can be generated by the computing device 110. In general, determining how cameras 112 should be positioned, placed, or moved about the workpiece 108 enhances the resulting visual data collected and provides a clearer view of the workpiece and parts.

In some embodiments, the material processing system 100 can monitor execution of the robotic program when processing (e.g., cutting) the desired part(s) from the input workpiece 108 and determine one or more follow-up actions for recommendation to the user. For instance, the system 100 can analyze the workpiece 108 during and/or after processing to perform at least one of feedback, certification, cataloging of remnants, or quality determination. As an example, the system 100 knows the shape of an idealized part and can generate a point cloud for comparison between the idealized part and the corresponding actual part cut from the workpiece 108 to determine the quality of each cut. In some embodiments, the system 100 performs up-to-code certification of the processing of the desired part(s) and automatically records the certification in the library 560, for example. This certification, which may be set in codes, may involve quality assessment of the processing (e.g., cut) of the part(s) that is verified by the set of non-contact sensors 112 (e.g., cameras). Each part can be graded and recorded regarding its condition post processing. Yet another follow-up action may involve the material processing system 100 adjusting one or more operating parameters of the system 100 in response to real-time observations during processing of the workpiece 108. An exemplary parameter can include a torch current adjusted in response to torch speed observations.

In various embodiments, the material processing system 100 can at any point in time use fewer non-contact sensors 112 (e.g., cameras) or lower resolution cameras 112 to identify the workpiece 108 and/or desired parts thereon and then orient path planning, path(s) of the torch 106 and/or the system 100 relative to the workpiece 108 for part generation or alignment (e.g., rotationally, angularity etc.). In some of these embodiments, the system 100 identifies and/or aligns the previously generated reference point cloud with the input workpiece 108 being observed using the set of fewer cameras 112 and/or lower resolution cameras 112, performing the alignment and preparation for processing and/or path planning with this comparison of a set of high-resolution image(s) with a set of low-resolution image(s) (e.g., requiring less data to properly align). For example, a workpiece can be scanned with a high quality/resolution camera prior to processing and the resulting high-resolution images of the workpiece can be stored in a catalog/database, such as in memory 560. When the workpiece is finally selected for processing, the set of sensors 112, which can comprise low-resolution cameras, may identify the specific workpiece in cooperation with the computing device 110 and retrieve the corresponding high-resolution file of the workpiece from memory 560 for subsequent analysis, such as path planning as described above. This allows for a better outcome without burdening the low-resolution cameras 112 or low-powered computing device 110. In some embodiments, creation of the reference point clouds and/or reference processing paths are performed at high resolution, whereas production of parts are processed at low resolution.

FIG. 9 shows another exemplary workpiece 1100 with parts 1102 that can be severed from the workpiece using the material processing system 100 of FIG. 1 by executing the path planning method 600 of FIG. 4, according to some embodiments of the present invention. In particular, the workpiece 1100 comprises an aluminum casting component that includes a set of runners 1102 as parts that are desired to be individually severed from the workpiece 1100. To perform such desired aluminum cast trimming highlighted in FIG. 9, the path planning application 500 of computing device 110 can generate a point cloud for the casting workpiece 1000 by reconstructing a set of multi-view images generated by the non-contact sensors 112 (implemented at steps 604 and 606 of process 600 of FIG. 4). Then, the path planning application 500 can locate within memory 560 a template point cloud of a sample/reference workpiece that is substantially the same in geometry as workpiece 1100 and with substantially the same runners to be trimmed (implemented in step 608 of process 600 of FIG. 4). The template point cloud for the reference workpiece is also associated with a set of template processing paths for guiding the system 100 to sever respective ones of the reference runners relative to the template point cloud of the reference workpiece. The path planning application 500 is adapted to match/align the template point cloud to the point cloud of the cast workpiece 1100 and project the template processing paths to the point cloud of the cast workpiece 1100 (implemented in step 612 of process 600). The projected processing paths constitute the recommended processing paths for trimming the runners 1102 from the cast workpiece 1100.

As described above, in various embodiments, the material processing system 100 utilizes image data from the non-contact sensors 112 along with process and system variables and attributes to create one or more processing paths for processing one or more desired parts from an input workpiece. The system can use the image data to generate a point cloud of the workpiece and/or part(s), locate and orient the part(s) to be processed, locate features of interest on the part(s) such as the visual indicators that inform the processing path(s). The present invention is adapted to reduce human involvement by (i) not requiring teaching of the path prior to path generation and/or (ii) not requiring touching of the part(s) to locate them or characterize their features/shapes. For example, in some embodiments as described above, template CAD/point cloud of a reference workpiece can provide one or more template processing path(s) to the computing device 110, based on which the computing device 110 can match the template CAD/point cloud of the reference workpiece to a point cloud of the input workpiece and project the template processing path(s) to the point cloud of the input workpiece to quickly generate a set of processing path(s) for the input workpiece. In addition, each of the resulting processing paths can be segmented such that one segment (e.g., a cut segment) can be up-sampled compared to another segment (e.g., an approach or retract segment) to minimize computation cost. Overall, these advantages reduce programming costs and requirements for designing processing path(s), reduce fixturing, reduce inspection requirements and produce better cutting outcomes.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

It should be understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A computer-implemented method for designing at least one processing path to process at least one part from a three-dimensional workpiece by a material processing system that comprises a torch coupled to a robotic arm, the method comprising:
receiving, by a computing device in electrical communication with the material processing system, material processing system data, part data for the at least one part to be processed, a template point cloud for a reference workpiece that comprises a set of spatial points defining the reference workpiece, and at least one template processing path for processing at least one reference part from the reference workpiece;
analyzing, by the computing device, the workpiece located within an operable envelope of the material processing system, the analyzing comprising:
locating, by the computing device, the workpiece within the operable envelope relative to the robotic arm;
generating, by the computing device, a workpiece point cloud comprising a set of spatial points defining the workpiece; and
aligning, by the computing device, the workpiece point cloud with the template point cloud to determine a spatial mapping between the workpiece and the reference workpiece; and
producing, by the computing device, a robotic program tailored to the workpiece, wherein the robotic program includes a processing path about the at least one part on the workpiece generated based on the template processing path and the spatial mapping.

2. The computer-implemented method of claim 1, wherein the processing path for the at least one part has a plurality of path segments comprising one or more of an approach path segment, a retract path segment, and a cut path segment, and wherein at least one of the plurality of path segments is up-sampled compared to another segment in the plurality of path segments.

3. The computer-implemented method of claim 1, wherein generating the processing path for the at least one part comprises:
aligning the at least one reference part of the reference workpiece with the at least one part of the workpiece based on the spatial mapping,
up-sampling the template processing path corresponding to the reference part,
and projecting the up-sampled template processing path onto the workpiece point cloud to generate the processing path.

4. The computer-implemented method of claim 1, wherein analyzing the workpiece further comprises scanning the workpiece to locate one or more visual indicators on the workpiece.

5. The computer-implemented method of claim 4, wherein the one or more visual indicators include at least one of a drawn marking, raised ridge, detent, plasma-arc friendly ridge or trough, or a textured surface or path.

6. The computer-implemented method of claim 5, further comprising adjusting, by the computing device, the generated processing path to interpolate the one or more visual indicators.

7. The computer-implemented method of claim 4, wherein the one or more visual indicators include a code embedded or cast into the workpiece.

8. The computer-implemented method of claim 7, further comprising adjusting, by the computing device, a plasma processing setting of the material processing system or a motion of the material processing system based on instructions included in the code.

9. The computer-implemented method of claim 4, wherein scanning the workpiece is performed by a set of non-contact sensors in electrical communication with the computing device, the computer-implemented method further comprises:
communicating, by the set of non-contact sensors, visual data of the workpiece to the computing device; and
reconstructing, by the computing device, an image of the workpiece based on the visual data to generate the workpiece point cloud.

10. The computer-implemented method of claim 9, wherein at least one of the set of non-contact sensors has dynamic movement.

11. The computer-implemented method of claim 9, wherein the set of non-contact sensors comprises a set of optical sensors.

12. The computer-implemented method of claim 9, wherein at least one of the set of optical sensors is focused on a specific region of the workpiece that includes the one or more visual indicators marked across the workpiece, and wherein the one or more visual indicators are up-sampled via the at least one optical sensor for adjusting the processing path.

13. The computer-implemented method of claim 1, wherein the at least one part to be processed from the workpiece comprises a plurality of parts to be processed, and wherein the at least one template processing path includes a plurality of template processing paths for processing corresponding ones of a plurality of reference parts from the reference workpiece.

14. The computer-implemented method of claim 13, further comprising generating a plurality of processing paths for respective ones of the plurality of parts by orienting and spatially mapping the plurality of reference parts of the reference workpiece to respective ones of the plurality of parts of the workpiece and projecting corresponding ones of the plurality of template processing paths on the workpiece to generate the plurality of processing paths.

15. The computer-implemented method of claim 14, wherein at least one processing path of the plurality of processing paths includes a plurality of path segments comprising an approach path segment, a retract path segment, and a cut path segment, and wherein at least one of the plurality of path segments is up-sampled.

16. The computer-implemented method of claim 15, further comprising adjusting one or more plasma settings of the torch to accommodate a set of robotic motions for the robotic arm to transit from one part to another part of the plurality of parts over the workpiece during processing.

17. The computer-implemented method of claim 1, wherein generating the robotic program tailored to the workpiece further comprises identifying a set of motions for the robotic arm and a set of plasma processing parameters for the torch to process the workpiece along the processing path to form the at least one part.

18. The computer-implemented method of claim 17, wherein the set of robotic motions comprises at least one of speed, angularity or tool center point (TCP) selection.

19. The computer-implemented method of claim 1, wherein the robotic program is generated for a plasma arc processing system.

20. The computer-implemented method of claim 1, further comprising performing up-to-code certification after the at least one part is processed from the workpiece in accordance with the robotic program and automatically recording the certification.

21. The computer-implemented method of claim 1, further comprising assessing the at least one part after being processed from the workpiece for at least one of feedback, certification, cataloging of remnants, or quality determination.

22. The computer-implemented method of claim 1, further comprising adjusting one or more operating parameters of the material processing system in response to real-time observations during processing of the workpiece in accordance with the robotic program.

23. The computer-implemented method of claim 22, wherein the one or more operating parameters comprises a torch current adjusted in response to torch speed observations.

24. The computer-implemented method of claim 1, further comprising actuating, by the computing device, the robotic arm of the material processing system to cut the at least one part from the workpiece based on the robotic program, including the processing path.

25. The computer-implemented method of claim 1, further comprising generating, by the computing device, the template point cloud and the at least one template processing path by:
scanning, by a set of sensors disposed about the operable envelope and in electrical communication with the computing device, images of the reference workpiece, wherein the reference workpiece includes a set of visual indicators illustrating a desired processing path about the reference part;
generating, by the computing device, the template point cloud comprising the set of spatial points defining the reference workpiece using a composite of the set of images; and
generating, by the computing device, the template processing path based on the visual indicators as captured by the set of images, the template processing path being defined by a set of spatial points interpolating one or more of the visual indicators and overlaying the template point cloud.

26. The computer-implemented method of claim 1, wherein aligning the workpiece point cloud with the template point cloud further comprises determining a spatial mapping between the at least one part on the workpiece and the at least one reference part on the reference workpiece.

27. A computer-implemented method for designing a processing path to process at least one part from a three-dimensional workpiece by a material processing system that comprises a torch coupled to a robotic frame having at least one robotic arm, the method comprising:
receiving, by a computing device in electrical communication with the material processing system, material processing system data, part data for the at least one part, and workpiece data for the workpiece, wherein the part data or the workpiece data includes a template processing path for guiding processing of the at least one part from the workpiece;
locating, by the computing device, the workpiece within an operable envelope relative to the robotic frame to detect one or more visual indicators on the workpiece;
generating, by the computing device, a workpiece point cloud for the workpiece located within the operable envelope, the workpiece point cloud includes a set of spatial points defining the workpiece;
projecting, by the computing device, the template processing path onto the workpiece point cloud to create an initial processing path for processing the part from the workpiece; and
generating, by the computing device, a final processing path by automatically adjusting the initial processing path based on the one or more visual indicators detected.

28. The computer-implemented method of claim 27, wherein the workpiece data corresponds to a reference workpiece having a similar geometry as the workpiece and the part data corresponds to a reference part having a similar geometry as the part to be processed from the workpiece.

29. The computer-implemented method of claim 28, wherein at least one of the workpiece data or the part data is a CAD model.

30. The computer-implemented method of claim 28, wherein at least one of the workpiece data or the part data is a point cloud.

31. The computer-implemented method of claim 28, wherein the template processing path corresponds to a path for processing the reference part from the reference workpiece.

32. The computer-implemented method of claim 28, further comprising aligning the workpiece point cloud corresponding to the workpiece with at least one of the workpiece data or the part data corresponding to the reference workpiece for guiding the projection of the template processing path onto the workpiece point cloud.

33. The computer-implemented method of claim 27, wherein the final processing path has a plurality of path segments comprising one or more of an approach path segment, a retract path segment, and a cut path segment, and wherein at least one of the plurality of path segments is up-sampled compared to the template processing path.

34. The computer-implemented method of claim 27, wherein locating the workpiece within the operable envelope relative to the robotic frame comprises scanning the workpiece to detect the one or more visual indicators on the workpiece.

35. The computer-implemented method of claim 34, wherein scanning the workpiece is performed by a set of non-contact sensors in electrical communication with the computing device.

36. The computer-implemented method of claim 27, wherein the one or more visual indicators include at least one of a drawn marking, raised ridge, detent, plasma-arc friendly ridge or trough, or a textured surface or path.

37. The computer-implemented method of claim 27, wherein adjusting the initial processing path comprises adapting the initial processing path to interpolate the one or more visual indicators.

38. The computer-implemented method of claim 27, wherein the one or more visual indicators include a code embedded or cast into the workpiece.

39. The computer-implemented method of claim 38, further comprising adjusting a plasma processing setting of the material processing system or a motion of the material processing system based on instructions included in the code.

40. A material processing system for cutting a part from a workpiece, the material processing system comprising:
a robotic arm possessing six degrees of freedom of movement in space;
a plasma arc torch operably connected to the robotic arm;
a plurality of cameras disposed about the robotic arm and oriented to selectively analyze the workpiece located within an operable envelope of the robotic arm to generate a plurality of images; and
a computing device in electrical communication with the plurality of cameras, the computing device configured to determine a processing path for the robotic arm across the workpiece based on a composite of the plurality of images.

41. The material processing system of claim 40, wherein the computing device is in electrical communication with the robotic arm and configured to actuate the robotic arm to cut the part from the workpiece following the processing path.

42. The material processing system of claim 40, further comprising a library in electrical communication with the computing device, the library configured to store at least one template point cloud comprising a set of spatial points defining a reference workpiece and a template processing path for processing at least one reference part from the reference workpiece.

43. The material processing system of claim 42, wherein the computing device includes:
an input module configured to receive from a user data related to the material processing system and data related to the part to be cut;
an analysis module configured to:
locate the workpiece within the operable envelope of the robotic arm using the plurality of images taken by one or more of the plurality of cameras;
generate a workpiece point cloud comprising a set of spatial points defining the workpiece; and
align the workpiece point cloud with the template point cloud to determine a spatial mapping between the workpiece and the reference workpiece and between the part and the reference part; and
a computation module configured to generate the processing path about the part on the workpiece by projecting the template processing path onto the workpiece point cloud based on the spatial mapping.

44. The material processing system of claim 43, wherein the computation module of the computing device is further configured to adjust the processing path based on one or more visual indicators on the workpiece captured in the plurality of images.

45. The material processing system of claim 40, wherein the computing device is configured to generate the processing path by interpolating one or more visual indicators on the workpiece about the part as captured in the plurality of images.

46. The material processing system of claim 40, wherein the computing device is further configured to identify at least one of a set of motions for the robotic arm or a set of plasma processing parameters for the plasma arc torch.

47. The material processing system of claim 46, wherein the set of robotic motions comprises at least one of speed, angularity or tool center point (TCP) selection.

48. The material processing system of claim 40, further comprising structured lighting disposed about the operable envelope to introduce lighting variations.
